(19) United States
(12) Patent Application Publication
(10) Pub. No.: US 2002/0148870 A1
(43) Pub. Date: Oct. 17, 2002

(54) Transporter for a greensmower and method of using

(76) Inventor: Dan T. Zimmerman, Corunna, IN (US)

Correspondence Address: HARTMAN & HARTMAN, P.C., 552 EAST 700 NORTH, VALPARAISO, IN, 46383, US

(21) Appl. No.: 10/063,378

(22) Filed: Apr. 17, 2002

Related U.S. Application Data
(60) Provisional application No. 60/284,272, filed on Apr. 17, 2001.

(51) Int. Cl. B60R 9/00; B60R 11/00

(52) U.S. Cl. 224/492; 224/508; 224/518

(57) ABSTRACT

A transporter and method for moving greensmowers from green to green. The transporter attaches directly to a utility vehicle, allows a greensmower to be loaded and unloaded without the use of a ramp and without mounting and dismounting wheels, and can be entirely suspended from the vehicle when transporting the greensmower. The transporter includes a transverse member that is pivotally coupled to the utility vehicle, and longitudinal members spaced apart from each other, substantially coplanar with each other, and cantilevered from the transverse member. The transporter further includes an arm interconnected with the transverse member so as to be operable to rotate the longitudinal members when the arm is raised and lowered. The arm can be selectively secured to a side portion of the utility vehicle when the longitudinal members are in a raised position.

### CROSS REFERENCE TO RELATED APPLICATIONS

This application claims the benefit of U.S. Provisional Application No. 60/284,272, filed Apr. 17, 2001.

### BACKGROUND OF INVENTION

1. Field of the Invention

The present invention relates to an apparatus for transporting a greensmower between greens on a golf course.

2. Description of the Related Art

Walking greensmowers are used to precisely cut the grass on the greens of a golf course. Because the greens are often several hundred yards apart, a greensmower must be transported between greens, typically on a trailer pulled by a utility vehicle or on a bed mounted to a utility vehicle. Greensmowers can weigh more than two hundred pounds, and therefore require a ramp to safely load them onto a trailer or cargo bed. There is inevitably a risk to the operator and greensmower during the loading and unloading operation, especially under rainy conditions when the ramp can become slippery. Furthermore, wheels must be installed on a greensmower to prevent contact of its reels and bedknives with hard surfaces on the trailer or bed. As a result, much time is involved in loading and unloading a greensmower, including the time required to mount and remove the greensmower wheels. If the operator neglects to use appropriate hold-down devices or such devices fail, a greensmower may separate from its trailers or bed and acquire significant damage as a result of bouncing that occurs with a trailer or cargo bed as the utility vehicle travels over a golf course. Finally, trailers should have a sheltered storage space, and have wheels, tires, bearings and bushings that must be maintained, adding cost to the greens maintenance program.

As an alternative to using a trailer or cargo bed, a greensmower can be driven from green to green on their own wheels while the operator walks. Another alternative is to equip a greensmower with a sulky on which the operator rides. However, transporting a greensmower from green to green in this manner subjects the reels and bedknives of the mower to possible damage from objects on the course. Furthermore, towing an operator on a sulky is not an option on soggy or hilly terrain. Similar to a trailer, a sulky has the additional cost of maintaining its wheels, tires, bearings and bushings.

From the above, it can be seen that it would be desirable if a better system were available for transporting a greensmower between greens.

### SUMMARY OF INVENTION

The present invention provides a transporter and method for moving greensmowers from green to green. The transporter can be attached directly to a utility vehicle, allows a greensmower to be loaded and unloaded without the use of a ramp and without mounting and dismounting wheels, and can be entirely suspended from the vehicle when transporting the greensmower. The transporter preferably has no moving parts that require maintenance.

The transporter of this invention generally includes a transverse member having oppositely-disposed ends, means for pivotally coupling the transverse member to a utility vehicle, and first and second longitudinal members spaced apart from each other, substantially coplanar with each other, and cantilevered from the transverse member. Each of the longitudinal members has a first end secured to the transverse member and an oppositely-disposed second end. The transporter further includes an arm interconnected with the transverse member so as to be operable to rotate the longitudinal members about an axis defined by the coupling means when the arm is raised and lowered. Means is provided for selectively securing the arm to a side portion of the utility vehicle when the longitudinal members are in a raised position.

The above construction of the transporter provides an uncomplicated method by which a greensmower can be transported with a utility vehicle by operating the arm to lower the second ends of the longitudinal members, moving the greensmower onto the first and second longitudinal members of the transporter so that an axle of the greensmower contacts and is supported on the longitudinal members, operating the arm to raise the second ends of the longitudinal members so as to lift the greensmower, and then securing the arm to the side portion of the utility vehicle with the securing means while the longitudinal members are in their raised position.

Other objects and advantages of this invention will be better appreciated from the following detailed description.

### BRIEF DESCRIPTION OF DRAWINGS

FIG. 1 represents a greensmower transporter in accordance with a preferred embodiment of the present invention.

FIG. 2 shows the transporter of FIG. 1 mounted to a utility vehicle in accordance with a first embodiment of this invention.

FIGS. 3 through 7 depict a procedure for loading a greensmower on the transporter of FIG. 1.

FIGS. 8 and 9 show accessories for mounting the transporter of FIG. 1 to a utility vehicle that differs from the vehicle represented in FIGS. 2 through 7.

### DETAILED DESCRIPTION

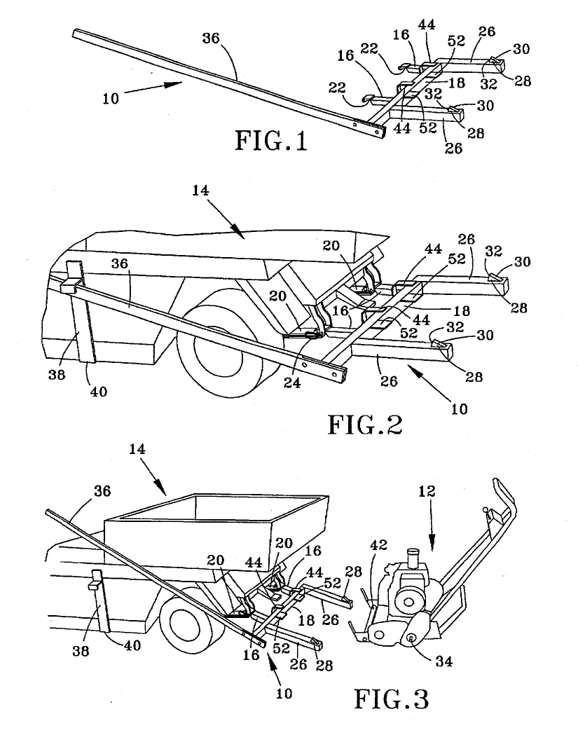

The Figures show a greensmower transporter 10 adapted to haul a greensmower 12 (FIGS. 3 through 7) from green to green without the use of a trailer or ramps and without the requirement to mount wheels to the greensmower 12. As can be seen from FIGS. 1 and 2, the transporter 10 does not require moving parts within itself, e.g., articulating joints, and as such requires very little maintenance. The transporter 10 attaches directly to a utility vehicle 14 and is entirely suspended from the vehicle 14 (FIGS. 2 through 7), freeing the operator from inconveniences associated with the use of a trailer, such as backing the trailer.

The construction of the transporter 10 is shown as being primarily of square steel tubes, though other constructions are foreseeable and essentially any sufficiently rigid and strong material could be used. As most readily seen in FIGS. 1 and 2, the transporter 10 has two mounting brackets 16 that extend forward of a transverse mainframe tube 18 having a substantially horizontal orientation. The brackets 16 terminate with semicircular bearing surfaces 22 that rest on the rear leaf spring assemblies 20 of the utility vehicle 14 inside the spring shackles. These two couples provide pivot points on which the entire weight of the transporter 10 and mower 12 rests. Hitch pins 24 can be used to secure the brackets 16 to the spring assemblies 20.

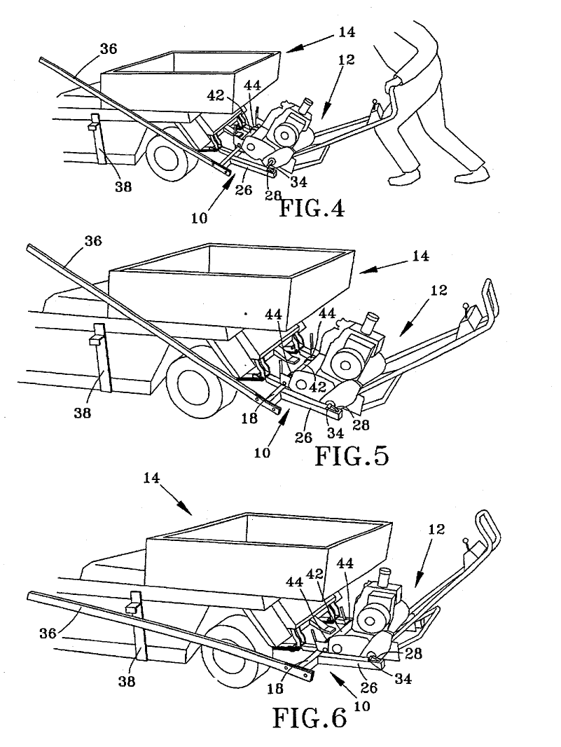

As also seen in FIGS. 1 and 2, the transporter 10 further includes side tubes 26 with forward ends that are fixedly attached to the mainframe tube 18, such as by welding. The side tubes 26 are substantially coplanar and preferably parallel, and extend rearwardly from the mainframe tube 18. A suitable length for each side tube 26 is about two feet (about one-half meter), though different lengths are foreseeable. As most readily seen in FIGS. 1 through 3, the side tubes 26 are preferably equipped with raised stops 28 near their rearmost ends. Each stop 28 has a generally triangular shape, with a sloping upper edge 30 and a front edge 32 that is substantially perpendicular to its respective side tube 26. As seen in FIGS. 5 through 7, the front edge 32 of each stop 28 engages the mower axle 34 to prevent the mower 12 from being disengaged from the transporter 10 once mounted. The mainframe and side tubes 18 and 26 preferably define a U-shape so that the sensitive reels and bedknives of the mower 12 never contact the transporter 10.

A lever 36 is shown as being fixedly secured (such as by welding) to the lefthand end of the mainframe tube 18, and extends forward alongside the utility vehicle 14. In the preferred embodiment shown, the lever 36 extends alongside the driver's side of the utility vehicle 14, ending adjacent the driver's seat. When the lever 36 is pivoted upward, the side tubes 26 of the transporter 10 are pivoted downward toward the ground, preferably until the ends of the side tubes 26 touch the ground. When the lever 36 is pivoted downward, the side tubes 26 of the transporter 10 are pivoted upward, lifting their rearward ends off the ground. The lever 36 is shown as being secured with a latch 38 mounted to the utility vehicle 14 near the driver's seat. The latch 38 preferably has a hook 40 or other suitable feature that holds its lower end to the lower edge of the vehicle frame, allowing the latch 38 to be secured to the vehicle 14 with a single bolt near its upper end. The latch 36 can remain on the vehicle 14 without interfering with its operation.

As seen in the sequence of FIGS. 3 through 7, the transporter 10 captures the greensmower 12 in such a way as to eliminate the need for conventional clamping and holding hardware. With the transporter 10 mounted to the rearward portion of the vehicle 14 as shown in FIG. 3, the lever 36 is raised to lower the rearward ends of the side tubes 26 toward ground level behind the vehicle 14, such that the side tubes 26 are inclined downwardly in a loading position. The mower 12 is then pushed or operated to travel onto the side tubes 26, riding over the raised stops 28, so that the axles 34 of the mower contact and are supported on the side tubes 26 as shown in FIG. 5. Simultaneously, the front of the mower 12 comes to rest on the mainframe tube 18, so that the front roller 42 rests on the mainframe tube 18 and a pair of support plates 52 projecting rearwardly from the mainframe tube 18, and the upper periphery of the roller 42 engages a pair of L-shaped brackets 44 that project upwardly from the mainframe tube 18 and then rearwardly over the front roller 42 to prevent the mower 12 from tipping backwards. As such, the raised stops 28 and the brackets 44 are able to secure the mower 12 while the side tubes 26 are still inclined.

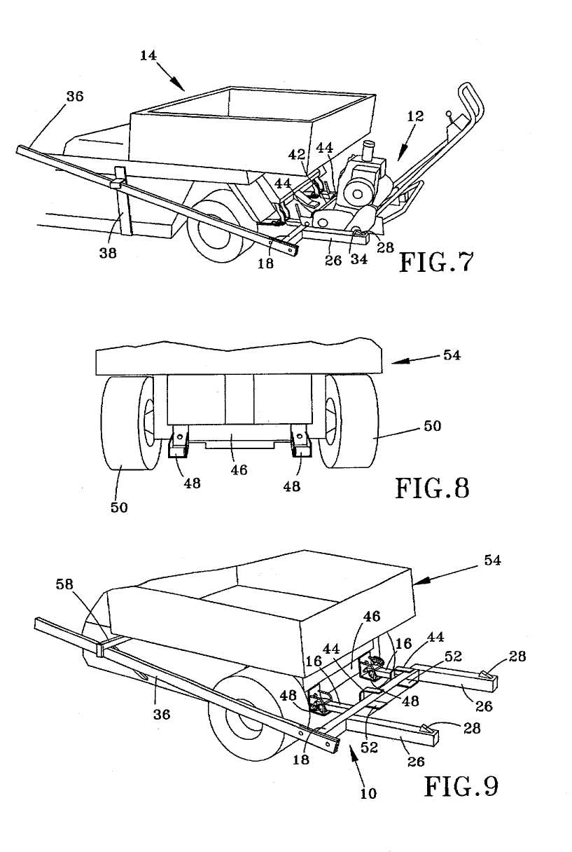

The lever 36 is then lowered to raise the rearward ends of the side tubes 26 and lift the mower 12, attaining a stowed position for the side tubes 26. The lever 36 is then secured with the latch 38 to the side of the vehicle 14 as shown in FIG. 6. FIG. 7 shows the mower 12 supported with its front roller 42 resting on the mainframe tube 18 and its axles 34 resting on the side tubes 26. The front roller 42 remains held by the brackets 44 and the axles 34 remain abutted the raised stops 28, such that the mower 12 is prevented 12 from being disengaged from the transporter 10 once mounted. As noted previously, the U-shape defined by the mainframe and side tubes 18 and 26 prevents the sensitive reels and bedknives (not shown) of the mower 12 from contacting any part of the transport 10.

In addition to simplifying the loading, transporting and unloading of a greensmower 12, the transporter 10 of this invention advantageously makes use of the spring assemblies 20 of the utility vehicle 14 to cushion the mower 12, thereby lessening the jostling of the mower 12 during hauling. The mainframe tube 18 is preferably parallel to the axis of rotation defined by the bearing surfaces 22, such that the mainframe tube 18 is able to provide a torque effect to further dampen jolts to the mower 12.

If a vehicle lacks an acceptable point for securing the brackets 16 of the transporter 10, the invention encompasses accessories shown in FIGS. 8 and 9 by which the transporter 10 can be mounted. In FIG. 8, a bracket 46 is mounted to the rear of a utility vehicle 54 in any suitable manner. The bracket 46 includes a crossbars 48 to which the brackets 16 and their bearing surfaces 22 can be coupled in a manner similar to that shown in FIG. 2. Because the rear wheels 50 of the vehicle 54 project out farther than those of the vehicle 14 shown in FIGS. 2 through 7, the vehicle 54 is equipped with a latch 58 modified to extend laterally outward from the side of the vehicle 54 to allow the lever 36 to be latched in essentially the same manner as described above.

While the invention has been described in terms of preferred embodiments, it is apparent that other forms could be adopted by one skilled in the art. For example, the transporter 10 could differ in appearance and construction from the embodiments shown in the Figures, and various materials could be used in its construction. Therefore, the scope of the invention is to be limited only by the following claims.

1. A greensmower transporter comprising:
a transverse member having oppositely-disposed ends;
means for pivotally coupling the transverse member to a rearward portion of a utility vehicle;
first and second longitudinal members spaced apart from each other, substantially coplanar with each other, and cantilevered in a first direction from the transverse member, each of the first and second longitudinal members having a first end secured to the transverse member and an oppositely-disposed second end;
an arm interconnected with the transverse member so as to be operable to rotate the first and second longitudinal members about an axis defined by the coupling means when the arm is raised and lowered; and
means for selectively securing the arm to a side portion of the utility vehicle when the first and second longitudinal members are in a raised position.

2. A greensmower transporter according to claim 1, wherein the first and second longitudinal members are substantially parallel to each other and have substantially equal lengths.

3. A greensmower transporter according to claim 1, wherein the first and second longitudinal members are elongate tubes.

4. A greensmower transporter according to claim 1, wherein the arm has a first end secured to the transverse member and an oppositely-disposed second end, and wherein the first longitudinal member is secured to the transverse member at a location on the transverse member between locations on the transverse member at which the arm and the second longitudinal member are secured thereto.

5. A greensmower transporter according to claim 1, wherein the transverse member and the coupling means are configured to orient the transverse member in a substantially horizontal orientation.

6. A greensmower transporter according to claim 1, wherein the transverse member and the coupling means are configured so that the transverse member rotates about the axis defined by the coupling means when the arm is raised and lowered.

7. A greensmower transporter according to claim 1, further comprising abutments projecting upwardly from the transverse member for bearing against a forward portion of a greensmower supported on the greensmower transporter.

8. A greensmower transporter according to claim 1, further comprising abutments on the first and second longitudinal members near the respective second ends thereof.

9. A greensmower transporter according to claim 8, wherein each of the abutments has a sloping upper edge, the height of each abutment above the first and second longitudinal members being defined by the sloping upper edge and increasing in a direction toward the transverse member, each abutment having an abutment face that is defined by an edge of the abutment nearest the transverse member and is substantially perpendicular to the first and second longitudinal members.

10. A greensmower transporter according to claim 1, wherein the greensmower transporter is mounted to the rearward portion of the utility vehicle.

11. A greensmower transporter mounted to a rearward portion of a utility vehicle and supporting a greensmower, the transporter comprising:
a transverse beam having oppositely-disposed lefthand and righthand ends;
means for pivotally coupling the transverse beam to the rearward portion of the utility vehicle so that the transverse beam is oriented to be substantially horizontal;
first and second longitudinal beams spaced apart from each other, substantially parallel to each other, and cantilevered in a rearward direction from the transverse beam, each of the first and second longitudinal beams having a forward end fixedly secured to the transverse beam at locations near the lefthand and righthand ends of the transverse beam, each of the first and second longitudinal beams having a rearward end extending rearwardly away from the transverse beam, each of the first and second longitudinal beams having a substantially horizontal stowed position and an inclined loading position;
an arm cantilevered from the transverse beam in a substantially forward direction, the arm having a rearward end fixedly secured to one of the lefthand and righthand ends of the transverse beam and an oppositely-disposed forward end located alongside a side portion of the utility vehicle, the arm being operable to rotate the first and second longitudinal beams about an axis defined by the coupling means and between the stowed and loading positions thereof when the forward end of the arm is lowered and raised, respectively, alongside the side portion of the utility vehicle;
and a latch mounted to the side portion of the utility vehicle for selectively securing the arm to the side portion of the utility vehicle when the first and second longitudinal beams are in the stowed position;
wherein the greensmower has an axle that is directly supported by the first and second longitudinal beams.

12. A greensmower transporter according to claim 11, wherein the transverse beam and the coupling means are configured so that the transverse beam is substantially parallel to the axis defined by the coupling means and rotates about the axis when the forward end of the arm is raised and lowered.

13. A greensmower transporter according to claim 11, further comprising:
at least one forward abutment projecting upwardly from the transverse beam and bearing against a forward portion of the greensmower supported on the greensmower transporter; and
rearward abutments on the first and second longitudinal beams near the respective rearward ends thereof, each of the rearward abutments having a sloping upper edge, the height of each rearward abutment above the first and second longitudinal beams being defined by the sloping upper edge thereof and increasing in a direction toward the transverse beam, each rearward abutment having an abutment face that is defined by an edge of the rearward abutment nearest the transverse beam and is substantially perpendicular to the first and second longitudinal beams, the abutment face of each rearward abutment bearing against a rearward portion of the greensmower supported on the greensmower transporter.

14. A greensmower transporter according to claim 11, wherein the utility vehicle has rear wheels and leaf spring suspension for the rear wheels, and the coupling means comprises a pair of bearing members engaged with the leaf spring suspension of the utility vehicle.

15. A method of transporting a greensmower with a utility vehicle, the method comprising the steps of:
mounting a greensmower transporter to a rearward portion of the utility vehicle, the transporter comprising:
a transverse member having oppositely-disposed ends;
means for pivotally coupling the transverse member to the rearward portion of the utility vehicle;
first and second longitudinal members spaced apart from each other, substantially coplanar with each other, and cantilevered in a rearward direction from the transverse member, each of the first and second longitudinal members having a forward end secured to the transverse member and an oppositely-disposed rearward end;
an arm interconnected with the transverse member so as to be operable to rotate the first and second longitudinal members about an axis defined by the coupling means when the forward end of the arm is raised and lowered; and
means for selectively securing the arm to a side portion of the utility vehicle;
operating the arm to lower the rearward ends of the first and second longitudinal members toward a surface behind the utility vehicle;
causing the greensmower to travel onto the first and second longitudinal members of the transporter so that an axle of the greensmower contacts and is supported on the first and second longitudinal members;
operating the arm to raise the rearward ends of the first and second longitudinal members so as to lift the greensmower; and then
securing the arm to the side portion of the utility vehicle with the securing means.

16. A method according to claim 15, wherein causing the greensmower to travel onto the first and second longitudinal members of the transporter results in a forward portion of the greensmower bearing against at least one abutment projecting upwardly from the transverse member.

17. A method according to claim 16, wherein the forward portion is a front roller of the greensmower.

18. A method according to claim 15, wherein during the step of causing the greensmower to travel onto the first and second longitudinal members of the transporter, the axle of the greensmower rides over a pair of rearward abutments on the first and second longitudinal members near the respective rearward ends thereof.

19. A method according to claim 18, wherein each of the rearward abutments has a sloping upper edge, the height of each rearward abutment above the first and second longitudinal members is defined by the sloping upper edge and increases in a direction toward the transverse member, each rearward abutment having an abutment face that is defined by an edge of the rearward abutment nearest the transverse member and is substantially perpendicular to the first and second longitudinal members, the abutment face of each rearward abutment bearing against the axle of the greensmower.

20. A method according to claim 15, wherein the coupling means comprises a pair of bearing members, and the step of mounting the transporter to the rearward portion of the utility vehicle comprises engaging the pair of bearing members with a leaf spring suspension of the utility vehicle.
